(19) United States
(12) Patent Application Publication
(10) Pub. No.: US 2025/0277340 A1
(43) Pub. Date: Sep. 4, 2025

(54) LAMINATED BODY AND METHOD OF MANUFACTURING LAMINATED BODY

(71) Applicant: CANON KABUSHIKI KAISHA, Tokyo (JP)

(72) Inventor: TATSUKI ABE, Tochigi (JP)

(21) Appl. No.: 19/064,467

(22) Filed: Feb. 26, 2025

(30) Foreign Application Priority Data
Feb. 29, 2024 (JP) 2024-030012

(51) Int. Cl. D21H 19/84; C08J 7/048; C09D 1/00; C09D 5/00; D21H 11/04; D21H 19/08; D21H 19/38; D21H 19/64; D21H 19/76

(52) U.S. Cl. CPC D21H 19/84; C08J 7/048; C09D 1/00; C09D 5/00; D21H 19/08; D21H 19/385; D21H 19/64; D21H 19/76; C08J 2301/02; D21H 11/04

(57) ABSTRACT

A laminated body includes a fiber base material, a first protection layer provided on each of front and back surfaces of the fiber base material, and a second protection layer that is provided on at least one of the front and back surfaces of the fiber base material and that is made of a material that absorbs ultraviolet rays. The first protection layer is made of a material having a gas barrier property that is higher than a gas barrier property of the second protection layer.

### BACKGROUND

### Technical Field

The present disclosure relates to a laminated body and a method of manufacturing the laminated body.

### Description of the Related Art

Plastic-free materials have been needed to suppress global warming and reduce negative impacts on ecosystems, and there has been growing demand for renewable natural fiber materials that have small impacts on ecosystems. Representative examples of such natural fiber materials include paper, which has been used for a wide range of application.

However, paper made of such natural fibers poses issues of degradation and durability as compared with plastic materials in many cases. For example, there are issues of change in color, degradation, and wavy edges caused by absorption of moisture, which may result in restrictions on use application. Especially paper containing plant fibers as raw material has a specific issue that a substance called lignin constituting fibers receives energy of ultraviolet rays, reacts with oxygen, and changes in color. To address this issue, various kinds of techniques have been studied to protect paper.

As a method of protecting such paper, known are a method of performing lamination using a transparent film capable of filtering out ultraviolet rays to prevent color fading and a method of coating paper with aluminum or resin having a water vapor barrier property to prevent moisture absorption in addition to an ultraviolet protection property.

Japanese Patent Application Laid-Open No. 2022-94130 discusses a technique of providing an ultraviolet protection layer containing resin and an inorganic compound as metal oxide that absorbs ultraviolet rays to add both the ultraviolet protection property and a gas barrier property to paper. The resin is disposed on a surface of paper, and the inorganic compound is disposed on a surface of the resin.

### SUMMARY

According to an aspect of the present disclosure, a laminated body includes a fiber base material, a first protection layer provided on each of front and back surfaces of the fiber base material, and a second protection layer that is provided on at least one of the front and back surfaces of the fiber base material and that is made of a material that absorbs ultraviolet rays, wherein the first protection layer is made of a material having a gas barrier property that is higher than a gas barrier property of the second protection layer.

Further features of the present disclosure will become apparent from the following description of exemplary embodiments with reference to the attached drawings.

### BRIEF DESCRIPTION OF THE DRAWINGS

FIG. 1 is a cross-sectional view of a laminated body.

FIG. 2 is a cross-sectional view of the laminated body.

FIG. 3 is a graph indicating a result of analyzing the laminated body.

### DESCRIPTION OF THE EMBODIMENTS

In the laminated body described in Japanese Patent Application Laid-Open No. 2022-94130, a resin layer is formed on a paper base material, which is considered to lead to deterioration of original functions of paper. For example, writing performance of the paper such as writing of characters with a writing instrument deteriorates and it becomes harder to perform printing on the paper.

The present disclosure is directed to provision of a laminated body that is capable of maintaining durability while maintaining writing performance and print performance.

An exemplary embodiment of the present disclosure will be described in detail below with reference to drawings.

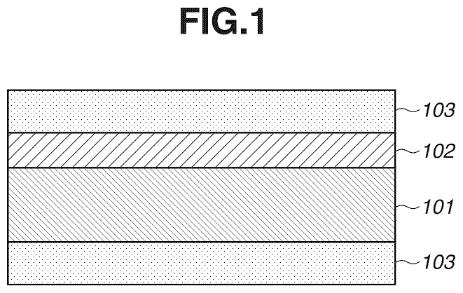

FIG. 1 is a cross-sectional view of a laminated body according to the present exemplary embodiment. A front surface and a back surface of a fiber base material 101 are covered with a gas barrier layer 103 (first protection layer), and at least one of surfaces on which writing or printing is performed is provided with, between the gas barrier layer 103 and the fiber base material 101, an ultraviolet protection layer 102 (second protection layer) for preventing ultraviolet rays from passing through the fiber base material 101.

In an example in FIG. 1, the ultraviolet protection layer 102 is provided only on the front surface, but may be provided in the entire region. That is, the ultraviolet protection layer 102 may be provided in the entire region between the fiber base material 101 and the gas barrier layer 103.

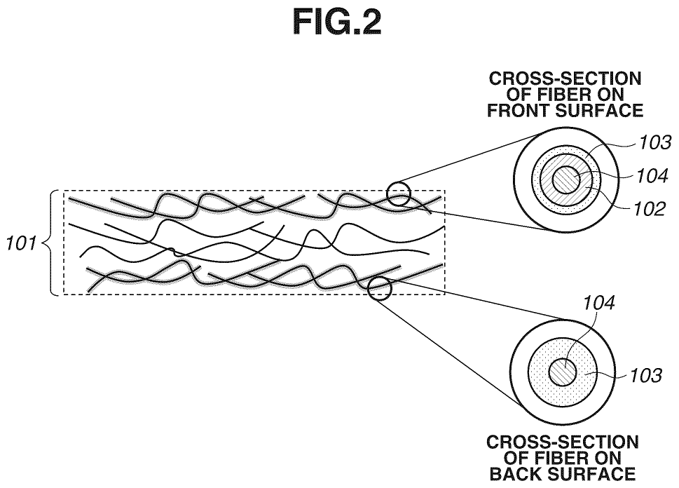

As illustrated in FIG. 2, the ultraviolet protection layer 102 and the gas barrier layer 103 may be provided so as to cover surfaces of fibers that are exposed on the front surface of the fiber base material 101. At this time, fibers 104 on at least one of the surfaces on which writing or printing is performed are provided with the ultraviolet protection layer 102 between each fiber 104 and the gas barrier layer 103, similarly to the example illustrated in FIG. 1.

That is, in both the example in FIG. 1 and the example in FIG. 2, when composition analysis is performed vertically from a planar direction of a paper surface to a thickness direction, two layers of the ultraviolet protection layer 102 and the gas barrier layer 103 are detected on one of the surfaces until the fiber base material 101 is detected. The laminated body is provided so that at least the gas barrier layer 103 is detected on the other surface.

Providing the gas barrier layers 103 on both the front surface and the back surface of the laminated body in this manner makes it possible to prevent water vapor and the like from penetrating into the fiber base material 101 and prevent the fiber base material 101 from absorbing moisture and becoming wavy. Providing the ultraviolet protection layer 102 between the fiber base material 101 and the gas barrier layer 103 on the surface on which writing or printing is performed (at least one surface) makes it possible to prevent the fiber base material 101 from changing in color due to the influence of ultraviolet rays.

In the examples in FIGS. 1 and 2, the description has been given of the example in which the ultraviolet protection layer 102 is provided between the fiber base material 101 and the gas barrier layer 103 on the surface on which writing or printing is performed, but the order of lamination of the ultraviolet protection layer 102 and the gas barrier layer 103 may be reversed. That is, the first layer on the fiber base material 101 (the surface of each fiber 104) may be the ultraviolet protection layer 102 and the second layer may be the gas barrier layer 103. Alternatively, the first layer may be the gas barrier layer 103 and the second layer may be the ultraviolet protection layer 102. In a case where three or more layers are provided, the order of layers is not limited to the example.

### <Fiber Base Material>

A material that is applicable as the fiber base material 101 is now described. A fiber base material made of natural fibers can be used as the fiber base material 101. However, the fiber base material 101 is not particularly limited to paper, and a raw material thereof may be plant fibers or animal fibers. As plant fibers, wood, cotton, hemp, and the like containing cellulose as a main component can be used. As animal fibers, raw silk, wool, and the like can be used. Note that a term “main component” means a component which is contained most in an object by weight and/or volume.

In a case where a paper base material is used as the fiber base material 101, the material may be paper or paperboard. Examples of paper can include newsprint paper, print/information paper, wrapping paper, sanitary paper, and hybrid paper. Examples of paperboard include cardboard base paper, paperboard for paper containers, building material base paper, paper tube base paper, and paperboard wrapping paper. The fiber base material 101 may be a fiber base material in a state where printing or writing has been performed on part thereof. For example, examples of the fiber base material 101 can include printed paper, cardboard, and a painting. Degradation due to ultraviolet rays and oxidation is not a phenomenon that occurs only in a fiber base material, and can similarly occur in, for example, paint and pigment. That is, the ultraviolet protection layer 102, the gas barrier layer 103, and the like may be laminated on a fiber base material into which paint or pigment is soaked or a fiber base material that retains paint or pigment.

### <Ultraviolet Protection Layer (Second Protection Layer)>

The material of the ultraviolet protection layer 102 is only required to be an inorganic compound, and is not limited to any of oxide, nitride, sulfide, carbide, and the like. However, it is preferable that the ultraviolet protection layer 102 have permeability with respect to a visible light range, and have an ultraviolet protection property with respect to an ultraviolet range. Hence, the material preferably has a bandgap of 2.5 eV or more and 4.4 eV or less, and more preferably has a bandgap of 3.1 eV or more and 4.4 eV or less in terms of aesthetic merit.

The reason that the ultraviolet protection property can be defined by a bandgap is because absorption of light by a substance depends on a bandgap of a material. When light with a wavelength of energy that is a bandgap or more enters the material, light is absorbed without passing through the material. A relationship between energy E and light is expressed by the following relational expression (1).

$$E = h v = hc / λ \qquad Expression ( 1 )$$

(h: Planck constant, v: frequency, c: light speed, and λ: wavelength)

Applying bandgap energy to E from a relationship of λ=1240/E makes it possible to identify a wavelength at which absorption starts to occur. For example, when a bandgap is 2.5 eV, light with a wavelength of approximately 500 nm or less is absorbed. When a bandgap is 4.4 eV, light with a wavelength of approximatively 280 nm or less is absorbed.

Because a wavelength of light that is recognizable by human eyes is generally approximately 400 nm to 750 nm, light is recognizable by the human eyes if the material has at least permeability with respect to light with a wavelength of approximately 500 nm. Thus, in this case, the material is assumed to have “permeability with respect to the visible light range”.

Light called ultraviolet rays generally has a wavelength of 400 nm or less. Especially among ultraviolet rays that are included in solar light when solar light reaches the surface of the ground, ultraviolet rays with a short wavelength are absorbed by the ozone layer, so that ultraviolet rays with wavelengths from 280 nm or more and 400 nm or less constitute the majority of soar light. Hence, if the material absorbs light with a wavelength in a range from 280 nm to 400 nm or less, the material is assumed to have “permeability with respect to the visible light range”.

The ultraviolet protection layer 102 having permeability with respect to the light visible range and the ultraviolet protection property is preferably made of a material having a bandgap of 2.5 eV or more and 4.4 eV or less.

Examples of the material with a bandgap of 2.5 eV or more and 4.4 eV or less can include zinc oxide, zinc sulfide, silicon carbide, titanium oxide, gallium nitride, and gallium sulfide, but the material is only required to have a bandgap in this range and is not limited to these examples.

An appropriate film thickness of the ultraviolet protection layer 102 is different depending on a bandgap of a material to be used, other optical characteristics, and, furthermore, an expected ultraviolet absorption rate that is different for application purposes. However, since it is not possible to obtain a sufficient absorption rate when the film thickness is too small, the ultraviolet protection layer 102 preferably has a film thickness of at least 30 nm or more. Because peeling occurs due to stress of a film when the film thickness is too large, the ultraviolet protection layer 102 preferably has a film thickness of 500 nm or less.

### <Gas Barrier Layer (First Protection Layer)>

The gas barrier layer 103 is only required to contain an inorganic compound, and a layer with a gas barrier property that is higher than at least a gas barrier property of the ultraviolet protection layer 102 is assumed to be the gas barrier layer 103 in the present exemplary embodiment. That is, the gas barrier layer 103 does not need to have a specific oxygen transmission rate nor a specific water vapor transmission rate, but it is preferable that the gas barrier layer 103 be made of alumina oxide, silicon oxide, or magnesium oxide, each of which is generally known as a material with the gas barrier property. As a criterion for having the gas barrier property, for example, when coating is performed on a polyethylene terephthalate (PET) film, an oxygen transmission rate is preferably 30 cm³/m²·day·atm or less, more preferably 10 cm³/m²·day·atm or less under a 20 C/65% RH condition.

Since the gas barrier layer 103 does not need to have the ultraviolet protection property, there is no upper limit of a bandgap. However, the gas barrier layer 103 needs to have permeability with respect to the visible light range, the material of the gas barrier layer 103 preferably has a bandgap of 2.5 eV or more. The material desirably has a bandgap of 3.1 eV or more in terms of aesthetic merit.

While an appropriate film thickness of the gas barrier layer 103 is different depending on the gas barrier property of the material to be used or an expected level of the gas barrier property, the gas barrier property appears if the material has a film thickness of at least 5 nm or more, so that the material preferably has a film thickness of 5 nm or more. Since peeling occurs due to stress of a film when the film thickness is too large, the gas barrier layer 103 preferably has a film thickness of 500 nm or less.

The reason that the ultraviolet protection layer 102 and the gas barrier layer 103 preferably contain the inorganic compound is that recyclability is needed for fiber base materials, especially paper, in terms of environmental protection. At present, in a case where fiber base materials are coated, most of these materials are coated with organic resin or the like. Even in a case of using organic resin, certain effects can be expected in terms of preventing degradation. However, in a case of using resin, it is difficult to separate the resin, which decreases a recycling rate. The material is determined as unrecyclable depending on conditions. The material contains an organic resin component, and thus is bad for the environment even if it is disposed of and considered to have a negative effect on ecosystems due to poor biodegradability. For the reasons mentioned above, the inorganic compound is preferable as the material of the laminated body obtained by lamination on the fiber base material 101.

### <Method of Manufacturing Laminated Body>

As a method of laminating the ultraviolet protection layer 102 and the gas barrier layer 103 on the fiber base material 101 and forming layers of the laminated body, chemical vapor deposition (CVD), physical vapor deposition (PVD), and the like can be used. Examples of the CDV can include plasma CVD using plasma and thermal CVD using heat. Examples of the PVD can include vacuum vapor deposition, ion assisted deposition, ionic plating, and sputtering.

As a more preferable layer formation method, atomic layer deposition (ALD) can be used. The ALD is, for example, a method discussed in Japanese Unexamined Patent Application Publication No. 2009-525406. In this method, it is possible to form a thin film in units of atomic layers while alternately repeating introduction and exhaustion of two or more kinds of raw material gas and reacting the raw material absorbed to the surface of a film formation target. More detailed steps by taking aluminum oxide as an example include (1) introducing raw material gas containing aluminum (trimethyl aluminum (CH₃)₃Al) and argon as inactive gas, thereafter (2) performing purging with the raw material gas, (3) injecting raw material gas containing oxygen (H₂O+O₂), and thereafter (4) performing purging with the raw material gas. The steps from (1) to (4) are referred to as one cycle, and repeating the cycle makes it possible to form a thin film one atomic layer by one atomic layer. Although film formation speed per cycle is different depending on conditions and materials, repeatability under an identical condition is high, and thus multiplying a film thickness formed at one cycle by the number of cycles makes it possible to obtain a desired film thickness.

The ALD is disadvantageous in slow film formation speed because thin films are laminated in units of atomic layers to form layers on the front surface of the film formation target using self-regulating characteristics of atoms. However, in a case where there are irregularities that are intrinsic to fibers on the front surface of a material such as the fiber base material 101, it is possible to form layers so as to wrap around irregularities on the front surface, and further wrap around each fiber. That is, it can be said that the ALD is preferable at the time of formation of the laminated body like the one illustrated in FIG. 2.

### Evaluation of Examples and Comparative Examples

Table 1 indicates respective configurations of Examples and Comparative Examples of the laminated body according to the present exemplary embodiment. These configurations are merely examples and the invention is not limited to these configurations. The configurations, film thicknesses, and film formation methods can be changed as appropriate. Evaluation regarding a bandgap, a gas barrier property, and writing performance was performed in each of Examples and each of Comparative Examples. However, evaluation regarding the bandgap and the gas barrier property was performed with respect to a single layer film for accurate evaluation of performance of a film, and evaluation regarding the writing performance was performed with a corresponding configuration of each of Examples and each of Comparative Examples.

TABLE 1

| | | | Film | | Film | |
|---|---|---|---|---|---|---|
| | | | configuration | | configuration | |
| | | | on front side | | on back side | |
| | | | Upper stage: | | Upper stage: | |
| | | | first layer | | first layer | |
| | | | (Fiber base | | (Fiber base | |
| | | Film | material) | Film | material) | Film |
| | Fiber base | formation | Lower stage: | thickness | Lower stage: | thickness |
| | material | method | second layer | (nm) | second layer | (nm) |
| Ex. 1 | Fine | ALD | Zinc oxide | 50 | Aluminum | 60 |
| | paper | | Aluminum | 50 | oxide | |
| | | | oxide | | | |
| Ex. 2 | Fine | ALD | Magnesium | 60 | Magnesium | 70 |
| | paper | | oxide | | oxide | |
| | | | Aluminum | 50 | Aluminum | 60 |
| | | | oxide | | oxide | |
| Ex. 3 | Fine | ALD | Titanium | 200 | Aluminum | 300 |
| | paper | | oxide | | oxide | |
| | | | Aluminum | 200 | | |
| | | | oxide | | | |
| Ex. 4 | Craft | ALD | Zinc oxide | 50 | Aluminum | 60 |
| | paper | | Aluminum | 50 | oxide | |
| | | | oxide | | | |
| Ex. 5 | Cardboard | ALD | Zinc oxide | 50 | Aluminum | 60 |
| | | | Aluminum | 50 | oxide | |
| | | | oxide | | | |
| Comp. | Fine | ALD | Zinc oxide | 50 | Zinc oxide | 50 |
| Ex. 1 | paper | | | | | |
| Comp. | Fine | ALD | Aluminum | 60 | Aluminum | 60 |
| Ex. 2 | paper | | oxide | | oxide | |
| Comp. | Fine | Bar | PVDC | 1000 to | PVDC | 1000 to |
| Ex. 3 | paper | coating | | 2000 | | 2000 |

### (Evaluation of Bandgap)

It is possible to measure a permeability rate and a reflection rate using, for example, a spectrophotometer, and calculate a bandgap using the Tauc plot. At this time, the evaluation regarding the ultraviolet protection property was performed assuming that a result was good when a bandgap of a single layer in a material to be used as an ultraviolet protection layer in the laminated body was more than 2.5 eV and 4.4 eV or less, and a result was poor when a bandgap was other values.

### (Evaluation of Gas Barrier Property)

The evaluation regarding the gas barrier property was performed by measurement of oxygen permeability with an oxygen permeability measurement device (OX-TRAN 2/22 manufactured by MOCON Ltd.). A 20 C/65% RH condition is used as a measurement condition. In the evaluation regarding the gas barrier property, if the evaluation is performed with respect to the laminated body containing the fiber base material like Examples and Comparative Examples, the shape of a fiber and a basis weight influence the evaluation, which leads to variations in evaluation. Hence, a single layer film made of a corresponding material used in each of Examples and each of Comparative Examples was formed on a PET film, and the evaluation regarding the gas barrier property was performed under an equal condition. In the present exemplary embodiment, the gas barrier property was not performed with a numeric value, but with the following criteria. The evaluation was performed by defining that a result was poor when the gas barrier property in the single layer film was more than 30 cm³/m²·day·atm, a result was fair when the gas barrier property was more than 10 cm³/m²·day·atm and 30 cm³/m²·day·atm or less, and a result was good when the gas barrier property was 10 cm³/m²·day·atm or less.

### (Evaluation of Writing Performance)

In the evaluation regarding the writing performance, writing was performed with a pencil B on the surface of a corresponding laminated body in each of Examples and each of Comparative Examples. When writing was performed with good writability that is equivalent to that of uncoated fine paper, a result was good. When writing was performed with poor writability due to slight slippage of a tip of the pencil, a result was fair. When writing was impossible, a result was poor.

Tables 2 and 3 respectively indicate results of evaluation of the bandgap and results of the gas barrier property with respect to the single layer film. It was confirmed this time that each of zinc oxide and titanium oxide selected as the ultraviolet protection layer had the bandgap in a range of more than 2.5 eV and 4.4 eV or less. It was confirmed that each of aluminum oxide and magnesium oxide selected as the gas barrier layer had the gas barrier property of 10 cm³/m²·day·atm or less.

TABLE 2

| | Bandgap |
|---|---|
| | eV |
| Zinc oxide | 3.2 |
| Titanium oxide | 3.1 |
| Aluminum oxide | 6.7 |
| Magnesium oxide | 7.6 |
| PVDC | Approximately 4.7 |

TABLE 3

| | Gas barrier property |
|---|---|
| | cm³/m² · day · atm |
| Zinc oxide | 45 |
| Titanium oxide | 40 |
| Aluminum oxide | 6 |
| Magnesium oxide | 8 |
| PVDC | 8 |
| Reference: base material PET (30 μm) | 40 to 50 |

Example 1 is now described. The laminated body was formed on the surface of the fiber base material 101 using fine paper (OK Prince Fine Paper manufactured by Oji Paper Co., Ltd., paper density: 81.4 g/m²) according to the ALD. Paper as a base material was fixed to, in a form of being attached to, a substrate holder in a film formation room, and film formation was performed. When the film formation was to be performed on the opposite side, the base material was turned upside down and the film formation was performed. Zinc oxide was selected as a material used as the ultraviolet protection layer, and aluminum oxide was selected as a material used as the gas barrier layer. Film formation speed for each material by the ALD performed this time was 1.8 Å per cycle for zinc oxide and 1.0 Å per cycle for aluminum oxide. The film formation was performed by repetition of the cycle until an intended film thickness indicated in Table 1 for each layer was obtained. Similarly, in subsequent Examples and Comparative Examples, film formation speed per cycle was calculated and the corresponding laminated body was obtained by repetition of film formation until a desired film thickness was obtained.

Example 2 is now described. The laminated body was formed on the surface using fine paper (OK Prince Fine Paper manufactured by Oji Paper Co., Ltd., paper density: 81.4 g/m²) according to the ALD. In Example 2, which was different from Example 1 in a fixing method, film formation was simultaneously performed on both sides using such a fixing method as to easily diffuse gas from both sides of paper. That is, a layer was formed on both sides in an exactly identical configuration. Zinc oxide was selected as a material used as the ultraviolet protection layer, and magnesium oxide was selected as a material used as the gas barrier layer. Since magnesium oxide has deliquesce, the ultraviolet protection layer was laminated on the gas barrier layer as the first layer.

Example 3 is now described. The laminated body was formed on the surface using fine paper (OK Prince Fine Paper manufactured by Oji Paper Co., Ltd., paper density: 81.4 g/m²) according to the ALD. Titanium oxide was selected as a material used as the ultraviolet protection layer, and aluminum oxide was selected as a material used as the gas barrier layer. A film formation method was similar to that in Example 1.

Example 4 is now described. The laminated body was formed using craft paper (G OLYMPUS manufactured by Nippon Paper Industries Co., Ltd., paper density: 85 g/m²) according to the ALD. Zinc oxide was selected as a material used as the ultraviolet protection layer, and aluminum oxide was selected as a material used as the gas barrier layer. A film formation method was similar to that in Example 1.

Example 5 is now described. The laminated body was formed using cardboard (K5/A flute) according to the ALD. Zinc oxide was selected as a material used as the ultraviolet protection layer, and aluminum oxide was selected as a material used as the gas barrier layer. A film formation method was similar to that in Example 1.

Comparative Example 1 is now described. The laminated body was formed using fine paper as the fiber base material according to the ALD.

Film formation was performed on the surface of the base material in a configuration in which a single layer made of zinc oxide used in Example 1 served as the ultraviolet protection layer as indicated in Table 1. A film formation method was similar to that in Example 2.

Comparative Example 2 is now described. The laminated body was formed using fine paper as the fiber base material according to the ALD. Film formation was performed on the surface of the base material in a configuration in which a single layer made of aluminum oxide used in Example 1 served as the gas barrier layer as indicated in Table 1. A film formation method was similar to that in Example 2.

Comparative Example 3 is now described. The laminated body was formed using fine paper as the fiber base material according to bar coating. As a material to be applied, polyvinylidene chloride (PVDC) emulsion (Diofan B204 manufactured by Solvay S.A.) was used. PVDC emulsion is known to have a high gas barrier property. An amount of PVDC emulsion to be applied was adjusted so that the film thickness was 1 to 2 μm.

Table 4 summarizes respective results in Examples and Comparative Examples. The writing performance was good in Examples 1 to 5 and Comparative Examples 1 and 2. This is considered to be because writing performance was high due to a small film thickness and remaining irregularities attributable to fibers on the surface. In contrast, in a case of resin in Comparative Example 3, it was confirmed that there was some slippage. It was confirmed that it was possible to form the laminated body not only on fine paper as the fiber base material, but also on craft paper and cardboard without problem.

TABLE 4

| | | | Film | Film | | | |
|---|---|---|---|---|---|---|---|
| | | | configuration | configuration | | | |
| | | | on front side | on back side | | | |
| | | | Upper stage: | Upper stage: | | | |
| | | | first layer | first layer | | | |
| | | | (Fiber base | (Fiber base | | | |
| | Fiber | Film | material) | material) | | Gas | |
| | base | formation | Lower stage: | Lower stage: | | barrier | Writing |
| | material | method | second layer | second layer | Bandgap | property | performance |
| Ex. 1 | Fine | ALD | Zinc oxide | Aluminum | Good | Good | Good |
| | paper | | Aluminum | oxide | | | |
| | | | oxide | | | | |
| Ex. 2 | Fine | ALD | Magnesium | Magnesium | Good | Good | Good |
| | paper | | oxide | oxide | | | |
| | | | Zinc oxide | Zinc oxide | | | |
| Ex. 3 | Fine | ALD | Titanium | Aluminum | Good | Good | Good |
| | paper | | oxide | oxide | | | |
| | | | Aluminum | | | | |
| | | | oxide | | | | |
| Ex. 4 | Craft | ALD | Zinc oxide | Aluminum | Good | Good | Good |
| | paper | | Aluminum | oxide | | | |
| | | | oxide | | | | |
| Ex. 5 | Cardboard | ALD | Zinc oxide | Aluminum | Good | Good | Good |
| | | | Aluminum | oxide | | | |
| | | | oxide | | | | |
| Comp. | Fine | ALD | Zinc oxide | Zinc oxide | Good | Poor | Good |
| Ex. 1 | paper | | | | | | |
| Comp. | Fine | ALD | Aluminum | Aluminum | Poor | Good | Good |
| Ex. 2 | paper | | oxide | oxide | | | |
| Comp. | Fine | Bar | PVDC | PVDC | Poor | Good | Fair |
| Ex. 3 | paper | coating | | | | | |

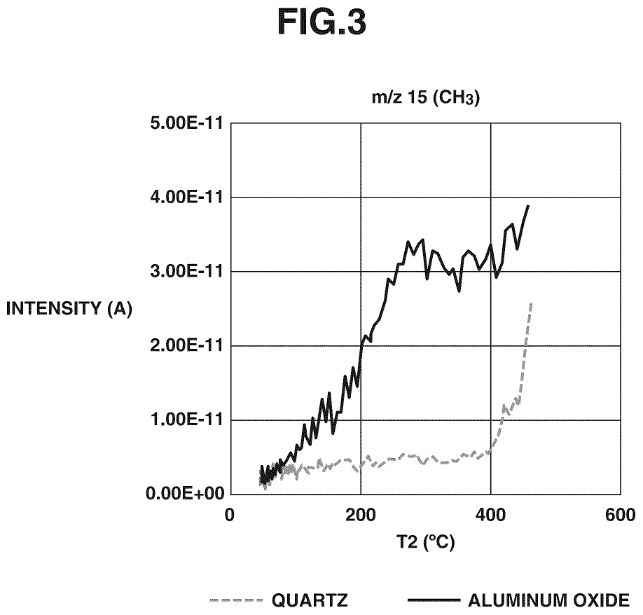

In Examples 1 to 5, it was confirmed that adhesiveness between the fiber base material 101 and a layer provided on the surface of the fiber base material 101 was high. This is considered to be because film formation using the ALD caused the laminated body to slightly contain hydrocarbon bonds, which lead to higher adhesiveness with cellulose as hydrocarbon. To address this issue, thermal desorption spectrometry (TDS) was performed in aluminum oxide used in Example 1. Heating was performed from a room temperature to 450° C. and mass spectrometry was performed using a thermal desorption spectrometry apparatus (EMD-WA1000S/W manufactured by ESCO, Ltd.). FIG. 3 indicates a spectrum of heated quartz as a reference and a result of aluminum oxide used in Example 1. A lot of desorption of CH3 component (m/z=15) was confirmed in comparison with quartz.

That is, with use of plant fibers containing cellulose as a main component as the fiber base material 101, performing film formation on the surface of the fiber base material 101 using the ALD makes it possible to provide the laminated body with higher adhesiveness.

With this configuration, it is possible to provide the laminated body that is capable of maintaining durability while maintaining writing performance and print performance.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-030012, filed Feb. 29, 2024, which is hereby incorporated by reference herein in its entirety.

What is claimed is:

1. A laminated body comprising:
a fiber base material having a front surface and a back surface;
a first protection layer provided on each of the front and back surfaces of the fiber base material; and
a second protection layer that is provided on at least one of the front and back surfaces of the fiber base material and that is made of a material that absorbs ultraviolet rays,
wherein the first protection layer is made of a material having a gas barrier property that is higher than a gas barrier property of the second protection layer.

2. The laminated body according to claim 1, wherein a material of the second protection layer has a bandgap of 2.5 eV or more and 4.4 eV or less.

3. The laminated body according to claim 1, wherein the fiber base material is a base material containing cellulose.

4. The laminated body according to claim 1, wherein each of the first protection layer and the second protection layer contains an inorganic metal compound.

5. The laminated body according to claim 4, wherein the inorganic metal compound contains at least one of zinc oxide, zinc sulfide, silicon carbide, titanium oxide, gallium nitride, or gallium sulfide.

6. The laminated body according to claim 1, wherein the first protection layer has a film thickness of 5 nm or more and 500 nm or less.

7. The laminated body according to claim 1, wherein the second protection layer has a film thickness of 30 nm or more and 500 nm or less.

8. The laminated body according to claim 1, wherein the second protection layer is provided between the fiber base material and the first protection layer.

9. A method of manufacturing a laminated body, the method comprising:
forming a second protection layer on at least one of front and back surfaces of a fiber base material, the second protection layer being made of a material that absorbs ultraviolet rays; and
forming a first protection layer on the front and back surfaces of the fiber base material, the first protection layer having a gas barrier property that is higher than a gas barrier property of the second protection layer.

10. The method of manufacturing a laminated body according to claim 9,
wherein the fiber base material is a base material containing cellulose, and
wherein each of the forming the second protection layer and the forming the first protection layer is performed with use of atomic layer deposition.
